(19) United States
(12) Patent Application Publication
(10) Pub. No.: US 2006/0106837 A1
(43) Pub. Date: May 18, 2006

(54) Parsing system and method of multi-document based on elements

(76) Inventor: Eun-Jeong Choi, Daejon (KR)

Correspondence Address: FLESHNER & KIM, LLP, P.O. BOX 221200, CHANTILLY, VA, 20153, US

(21) Appl. No.: 10/539,762

(22) PCT Filed: Nov. 26, 2003
(86) PCT No.: PCT/KR03/02569

§ 371 Date: Jun. 20, 2005

(30) Foreign Application Priority Data
Nov. 26, 2002 (KR) 10-2002-0074009

(51) Int. Cl. G06F 17/00; G06F 7/00

(52) U.S. Cl. 707/101

(57) ABSTRACT

A system and method is configured to parse web-document based on elements. The system can include a word parser for extracting and separating all tokens of the document supplied to the terminal regardless of kind of a markup language used to compose the web-document by referring to a token table; and a syntax parser for parsing syntax for the tokens extracted and separated by the word parser on the basis of a contents model, and generating a object on the basis of GUI of the terminal through the parsed syntax. The token table can include tokens defined in an XML document, keywords defined in document type definition (DTD) for all documents provided to the handheld terminal, and a list of elements that can be supported by each terminal. The contents model can be determined in accordance with DTD for all documents provided to the terminal and include a hierarchy of elements and an attribute list.

### TECHNICAL FIELD

The present invention relates to a parser for browsing a web-document on a handheld terminal, and more particularly, to a web-document integral parsing system and method for integrally supporting web-documents composed of various kinds of markup languages.

### BACKGROUND ART

FIG. 1 illustrates a schematic configuration in which a web-document is browsed on a handheld terminal according to the related art.

Referring to FIG. 1, a web-server 130 is provided with web-documents composed of various markup languages. A handheld terminal 110 is provided with browsers supplying each of the markup languages, such as handheld device markup language (HDML) browser 111, a wireless markup language (WML) web-browser 112 and a mobile hypertext markup language (mHTML) web-browser 113, and connects to a Web-server 130 directly or through a WAP gateway 120 to browse the corresponding web-document.

According to this configuration, since one terminal should be provided with a number of browsers equal to the number of the supported markup languages to browse various kinds of web-documents, the configuration of the handheld terminal is complex.

Accordingly, today, as the handheld telephone is widely used, the markup languages derived from conventional Hyper Text Markup Language (HTML) appear so as to support wireless Internet service.

The reason why the wireless Internet service is not provided using the conventional HTML but the other markup languages have been developed is the constraint of the wireless channel and the constraint of the handheld terminal. The mobile terminal itself such as the current handheld telephone has a smaller window size compared with a desktop computer used in wire Internet and an inferior computer performance in its central process unit (CPU) and memory compared with a desktop personal computer. However, since HTML provided by the conventional wire Internet has a lot of functions and is complex to be processed, it is difficult for the handheld terminal to support HTML.

For this reason, the markup languages, which inherit some functions of HTML and are specialized for each terminal, have been developed. For examples, HDML, WML, mHTML and compact HTML (cHTML) appear and are serviced.

However, the above mentioned markup languages were separately developed considering characteristics of service provider and terminals and are not compatible to one another. In other words, when an Internet service provider intends to provide two kinds of terminals with the same contents, the Internet service provider should develop two contents so that the contents follow the markup rules to be processed in each kind of terminal. A terminal user cannot see the content provided by another Internet service provider.

### DISCLOSURE OF THE INVENTION

Accordingly, the present invention is directed to system and method for parsing multi-document based on elements, which substantially obviate one or more of the problems due to limitations and disadvantages of the related art.

An object of the present invention is to provide a system and a method for parsing a web-document based on elements in which the contents composed of various markup languages provided from the conventional wire and wireless web sites can be integrally browsed regardless of the specification of a handheld terminal.

Another object of the present invention is to provide system and a method for parsing a web-document based on elements in which the elements that can be processed in the terminal are selected to be stored as data while the characteristics of different markup languages is analyzed and a document is parsed on the basis of elements, so that Internet service band are expanded.

Additional features and advantages of the invention will be set forth in the description which follows, and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, a system for parsing a web-document based on elements, which calls the web-document to provide it to an application of a handheld terminal, includes: a word parser for separating and generating a token on the basis of markup and non-markup by referring to a token table for all markup data necessary for kind of document to be supported; and a syntax parser for parsing a contents model on the basis of document type definition (DTD) of each document, parsing each syntax on the basis of the result of parsing the contents model, and generating a tree-based object on the basis of graphic user interface (GUI) of the terminal.

The word parser includes: a comment parser for processing a comment and a space; a markup start parser for recognizing a markup start tag and generating a token; an attribute parser for parsing an attribute and generating a token; and a parsed character data analyzer for analyzing parsed character data and generating a token. The syntax parser includes: an XML verifier for verifying whether a corresponding document is composed suitable for each DTD on the basis of the token generated by the word parser; and a terminal GUI-based object generator for matching the analyzed markup and a GUI of the terminal.

To further achieve these and other advantages and in accordance with the purpose of the present invention, a method for parsing a called web-document of a web-server, includes the steps of: (a) reading a token from the web-document and parsing the token; (b) if the token is not a defined start tag or if the token is a comment or a space as result of the step (a), ignoring the token, and when the defined start tag is read, parsing an attribute of an element from the token; (c) parsing the attribute of the element from the token, storing GUI-related information of the element, and parsing contents of the element; (d) as the result of the step (c), if the contents of the element are parsed character data, storing GUI-related information of the contents, and if the contents of the element are not the parsed character data, reading data until an end tag appears; and (e) in case the contents of the element are not the parsed character data, if the end tag corresponding to the start tag defined appears, terminating, and if the end tag does not appear, ignoring and returning.

To further achieve these and other advantages and in accordance with the purpose of the present invention, a handheld terminal includes: an integral parser for parsing a web-document composed of a predetermined markup language supplied from a web-server, a memory for storing information parsed by the integral parser; and an application program using information extracted from the integral parser.

Here, the integral parser includes: a token table including tokens defined in an XML document, keywords defined in DTD for all documents provided to the handheld terminal, and a list of elements which can be supported by each of the handheld terminals; a word parser for extracting and separating all tokens of the document supplied to the terminal regardless of kind of a markup language used to compose the web-document by referring to a token table; a contents model defined in DTD for all documents provided to the terminal and meaning a hierarchy of the elements and an attribute list; and a syntax parser for parsing syntax for the tokens extracted and separated by the word parser on the basis of contents model, and generating a object on the basis of GUI of the terminal through the parsed syntax.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates a schematic configuration in which a web-document is browsed on a handheld terminal according to the related art;

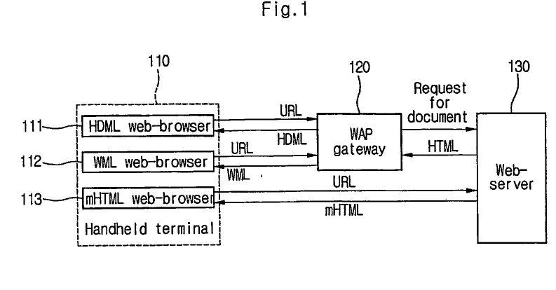

FIG. 2 is a block diagram illustrating that a web-document is browsed on a handheld terminal by using a web-document parsing system according to an embodiment of the present invention;

FIG. 3 illustrates an internal configuration of a handheld terminal employing a web-document parsing system according to an embodiment of the present invention;

FIG. 4 illustrates a schematic configuration of a web-document parsing system according to the present invention;

FIG. 5 is a schematic diagrams illustrating operation of word parser shown in FIG. 4;

FIG. 6 is an example of grammar structure according to the present invention; and

FIG. 7 is a flowchart illustrating a parsing procedure of integrated parser according to an embodiment of the present invention.

### BEST MODE FOR CARRYING OUT THE INVENTION

Hereinafter, preferred embodiments of the present invention will be described in detail with reference to accompanying drawings. Here, the same reference numbers are assigned with respect to elements consisting of one pair and each of the pair is subdivided using an English letter.

In the present invention, the configuration is suggested in which a webpage is called to parse the called webpage based on elements and the extracted information is transferred to an application program in order to provide a user with all the kinds of contents such as supplied from an existing web-server constructed on Internet regardless of the limitation of the handheld terminal. The currently serviced markup languages are classified into three kinds as shown in Table 1.

TABLE 1

| | Single | | |
|---|---|---|---|
| | document | Embedment type | Modulization |
| Classification | structure | structure | structure |
| Markup | XHTML | WML2 | XHTML |
| language | | | modulization |
| | WML | Different manner | |
| | | using namespace | |
| | CHTML | Method | |
| | | embedding a markup | |
| | | language | |
| | MHTML | Object | |
| | | embedment using an | |
| | | object tag | |
| | HTML | Object | |
| | | embedment using | |
| | | protocol | |

Referring to Table. 1, in the classified markup languages, most of documents except for an HTML document have been developed on the basis of XML and it is being changed from HTML to XML. Accordingly, in the present invention, an embodiment of an integral parsing system is disclosed on the basis of markup languages based on XML.

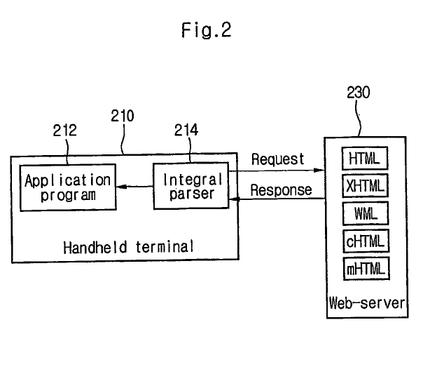

FIG. 2 is a block diagram illustrating overall configuration in which a web-document is browsed on a handheld terminal by using a web-document parsing system according to the present invention.

Referring to FIG. 2, in the present invention, a web-document composed of a predetermined markup language is supplied from a web-server 230. A handheld terminal 210 to which the present invention is applied includes an integral parser 214 for parsing the web-document composed of a predetermined markup language, which is supplied from the web-server 230, and an application program 212 using information extracted from the integral parser 214.

Here, the integral parser 214 receives the web-document composed of various markup languages, which is supplied from the web-server 230, and outputs information required for the application program 212 from the data stored in a memory or a hard disc (not shown).

In other words, the document supplied from the web-server 230 includes all the documents composed for presentation on the basis of SGML or XML such as XHTML, mHTML, cHTML, WML and HDML as well as HTML. Most of the markup languages such as XHTML, mHTML, cHTML, WML and HDML are defined with only some functions of HTML. WML has some additional defined elements.

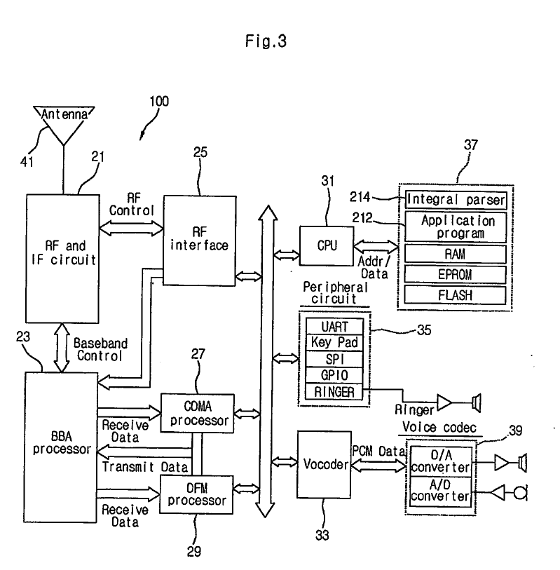

FIG. 3 illustrates an internal configuration of a handheld terminal employing a web-document parsing system according to an embodiment of the present invention.

This is for illustrating an embodiment of the handheld terminal. The handheld terminal of the present invention is not limited to the configuration of FIG. 3. The handheld terminal is a common designation of handheld telephone, PDA, etc.

Referring to FIG. 3, the basic functions and operations of the handheld terminal will be described as follows.

The handheld terminal 100 according to the present invention includes an antenna 41, an RF and IF circuit 21, a base band analog (BBA) processor 23, an RF interface 25, a code division multiple access (CDMA) processor 27, a digital FM (DFM) IS-95A processor 29, a CPU 31, a vocoder 33, a peripheral circuit 35, a memory 37 and a voice codec 39.

Here, the memory 37 includes an integral parser 214 for parsing the web-document composed of a predetermined markup language, which is supplied from the web-server 230, and an application program 212 using information extracted from the integral parser 214.

Here, the integral parser 214 receives the web-document composed of various markup languages, which is supplied from the web-server 230, and outputs information required for the application program 212 from the data stored in a RAM, EPROM, Flash memory, etc.

The peripheral circuit 35 includes a universal asynchronous receiver transmit (UART) circuit, a keypad, an SPI, a GPIO, a ringer, etc. The memory 37 includes a RAM, an EPROM, a Flash memory, etc. The vocoder 33 includes a CDMA vocoder and a DFM vocoder.

Also, the voice codec 39 has an analogo-digital converter and a digital-to-analog converter. The voice codec 39 performs analog-to-digital conversion in transmission mode and digital-to-analog conversion in reception mode.

When the terminal 100 transmits a voice signal, the voice codec 39 converts an analog signal generated by a microphone into a digital signal and transmits the digital signal to the vocoder 33. In CDMA mode, the CDMA processor 27 and a CDMA vocoder of the vocoder 33 process a signal. For DFM analog IS-95A used in analog modes (AMPS, TACT, etc.), the DFM processor 29 and a DFM vocoder of the vocoder 33 process a signal.

The output of the vocoder 33 is inputted to the selected CDMA processor 27 or the DFM processor 29 to be processed, then inputted to the BBA processor 23, then converted into a base band signal, then inputted to the RF and IF circuit 21 and then transmitted through the antenna 41.

When the terminal 100 is in reception mode, the RF and IF circuit 21 converts a RF signal received through the antenna 41 into a base band signal, and then the BBA processor 23 converts the base band signal into a digital signal. The digital signal is inputted to the CDMA processor 27 and the DFM processor 29. The CDMA processor 27 and the DFM processor 29 process the digital signal and output the processed signals to the vocoder 33. The vocoder 33 converts the inputted signal into data of pulse code modulation (PCM) format and outputs the data to the voice codec 39. The voice codec 39 converts the data into an analog signal and outputs the analog signal to a speaker or an earphone.

The signal to control the RF and IF circuit 21 and the BBA processor 23, that is, an offset and gain control signal is transferred through the RF interface 25. Besides, the CPU 31 controls overall system, especially a ring function and an interface with key through the peripheral circuit 35.

The handheld terminal of the present invention includes an integral parser 214 and an application program 212 using the information extracted from the integral parser 214 in contrast to the conventional handheld terminal. The handheld terminal calls a webpage to parse the called webpage on the basis of elements and transfers the extracted information to the application program in order to provide a user with all the kinds of contents supplied from an existing web-server constructed on Internet regardless of the limitation of the handheld terminal.

The integral parser employed in the handheld terminal 100 of the present invention, that is, the web-document parsing system 214 will be described in detail.

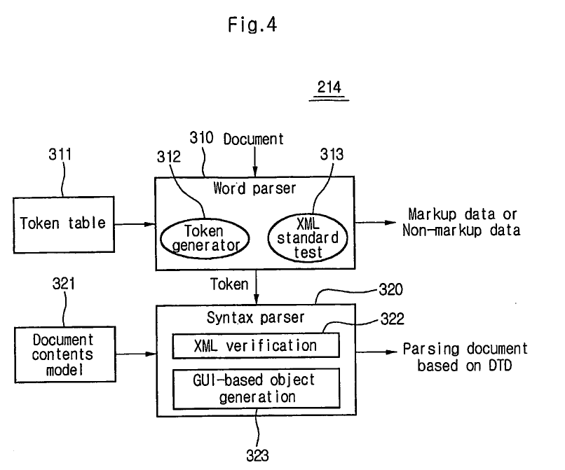

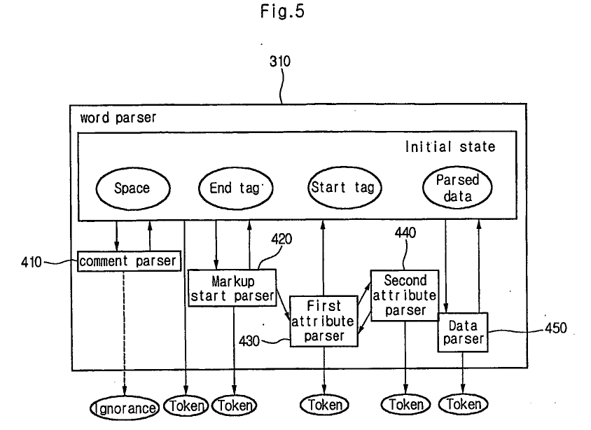

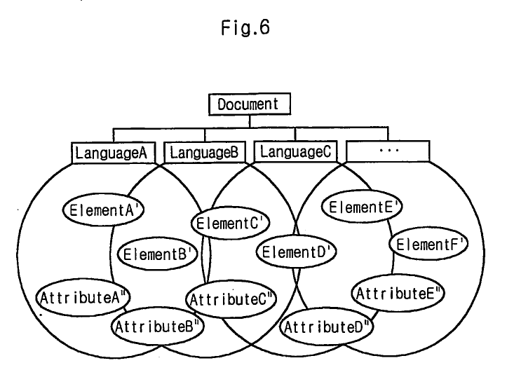

FIG. 4 illustrates a schematic configuration of a web-document parsing system according to the present invention. FIG. 5 is a schematic diagram illustrating operation of a word parser shown in FIG. 4. FIG. 6 is an example of grammar structure according to the present invention.

The parsing system 214 of the present invention includes a word parser 310 and a syntax parser 320 as shown in FIG. 4. The word parser 310 separates a token on the basis of markup and non-markup with referring to a token table 311 for all markup data necessary for kind of a document to be supported.

Here, the word parser 310 is performed on the document composed for presentation on the basis of SGML or XML such as XHTML, mHTML, cHTML, WML and HDML as well as HTML.

The token table includes tokens (e.g.<,>,“,”,‘,’,=, etc.) defined in an XML document and keywords (e.g. html, wml, name, align, etc.) defined in all the DTD to be supported, and further includes a list of the elements that can be supported by each terminal.

Here, the token means a basic language element that cannot be further divided grammatically, for example, a keyword, an operator punctuation mark, etc. The token table 311 is included in each terminal.

In other words, the word parser 310 separates all the tokens of a document supplied to the integral parser 214 on the basis of markup and non-markup by using the token table 311.

Accordingly, the integral parser 214 ignores only a markup portion of the element that is not supported by the terminal 210, that is, tag name (element type) and attributes (attribute list), and browses a non-markup portion such as parsed character data for a user.

For example, in the case of <p align=”center”>Hello world!</p>, the terminal that does not support p element ignores markup data between “<” and “>” and browses the parsed character data “Hello world!” for the user.

Also, the integral parser 214 generates object that represents the structure of the supplied document as to the markup portion of the element. In other words, the integral parser 214 parses the element and generates the corresponding GUI object. In general, a parser creates a document object model in tree format so that an application program 212 can performs selection freely.

The syntax parser 320 browses predetermined data through a token extracted by the word parser for the user.

The syntax parser 320 includes an XML verifier 322 and a GUI-based object generator 323, and helps the documents of all the markup languages be browsed properly on each of the handheld terminals. The syntax parser 320 parses a contents model 321 on the basis of DTD of each document, parses each syntax on the basis of the result of the parsing the contents model 321, and generates a tree-based object on the basis of GUI of the terminal to provide the tree-based object as the rendering data.

Here, the contents model 321 means a hierarchy of elements and an attribute list (attributes), and is defined in DTD. For example, HTML has body and head as lower elements. WML has head and card as lower elements. Here, card is as the same level as body since card represents one page. WeM is as the same level as HTML since WML represents one document.

The hierarchy of the elements is analyzed and used to design the grammar of the syntax parser 320.

In addition, the GUI-based tree object corresponds to an application program 212 of a terminal 210 shown in FIGS. 2 and 3.

In other words, the grammar of the syntax parser 320 on the basis of the contents model 321 is constituted. Accordingly, the syntax parser 320 parses the input document to create a GUI model.

In the document provided to the integral parser 214, the token of the document extracted through the word parser 310 and the token table 311 is inputted to the syntax parser 320 and browed for the user. Here, the XML verifier of the syntax parser 320 parses the syntax on the basis of the contents model 321. The GUI-based object generator 323 cooperates with the XML verifier 322 to generate GUI-based object. In other words, when the XML verifier 322 performs contents model analysis on one element in the input document, the GUI-based object generator 323 generates the corresponding GUI-based object.

Here, with relation to the word parsing process of the word parser 310 and the syntax parsing process of the syntax parser 320, the syntax parsing process does not begin only after all the word parsing process is completed. The word parser 310 is requested to provide a token whenever a parsing state of the syntax parser 320, that is, a syntax parsing state or context is changed. In other words, the word parser 310 and the syntax parser 320 cooperate with each other.

The word parser 310 includes a token generator 312 and an XML well-formedness verifier 313, and extracts the token on the basis of the XML well-formedness standard. Here, a token table is made of all the tokens of the documents to be supported.

In addition, as shown in FIG. 5, a state is changed to separate a token according to XML structure.

As described above, the token means a basic language element that cannot be further divided grammatically. The word parser 310 scans the document character supplied to the integral parser 214 character by character, recognizes a token of the document on the basis of the token table 311, and parses and extracts the token by using the token generator 312 and the XML well-formedness verifier 313. When the extracted tokens are transferred to the syntax parser 320, the syntax parser 320 parses the syntax of the document on the basis of the tokens.

The token generator shown in FIG. 4 means structure of a program including a token type and a string. For example, if there is the string “html” in the document provided to the integral parser 214, the syntax parser is informed that its element type is HTML and it is a token consisting of four characters “html”.

In the document supplied to the integral parser 214, that is, the web-document, a string has a different token according to whether it is a markup or a non-markup in contrast to a general programming language. For example, in the case of <html>, <p>html</p> and <!--html-->, the html is classified into a different token. <html> represents an element type. <p>html</p> represents parsed character data. <!--html--> represents a comment. Therefore, <html>, <p>html</p> and <!--html--> have different tokens from each other.

Consequently, as for the state of the token, different tokens can be extracted from even the same word according to the state of the word parser 310. The word parser 310 classifies the tokens into a comment, a start tag and parsed character data, and parses them.

In other words, the states of the word parser 310 are classified into a comment, a start tag, an attribute (e.g. attrStart and attValue) and parsed character data.

Referring to FIG. 5, in general, a web-document includes a space, a start tag and an end tag. The word parser 310 of the present invention parses the web-document to generates a token by using a comment parser 410, a markup start parser 420, a first attribute parser 430, a second attribute parser 440 and a data parser 450.

In other words, at the initial state, a space, a beginning of a start tag “<”, a beginning of an end tag “</”, a beginning of a comment “<!--” and parsed data may come. According to the types of the tokens recognized at the initial state, the different parsers recognize the next tokens, respectively. When each of the parsers recognizes the token, the recognized tokens are transferred to the syntax parser. Then, it is determined whether to maintain the parsing state or to return to initial state according to the type of the next token. Here, in the case of returning to the initial state, the processes are repeated.

Here, the space can include at least one space, carriage returns, line feeds and tabs.

In addition, the first and second attribute parsers 430 and 440 can be replaced with one attribute parser. In other words, the first attribute parser 430 is a routine for recognizing a name of an attribute and the second attribute parser 440 is a routine for recognizing a value of the attribute. The value of the attribute may be a general character string or a key word such as center, left or right.

Here, if the value of the attribute is the keyword, the first attribute parser 430 recognizes the name and the value of the attribute at once without distinguishing the name from the value. For example, in the case of title=“welcome to my homepage”, both of the first and second attribute parsers 430 and 440 are required but in the case of align=“center”, the second attribute parser 440 is not required since only the first attribute parser 430 recognizes the name and the value.

In summary, the word parser 310 parses a document on the basis of XML Well-formedness standard and extracts a token. The syntax parser 320 checks whether the document is composed suitable for DTD by using the token extracted by the word parser 310, and make the parsed markup match GUI of the terminal.

In other words, the syntax parser 320 performs mapping operation so as to represent a GUI model of a specific markup language by GUI supported by the handheld terminal regardless of a specific markup language.

The reason why the mapping operation is preformed is as follows. Since the handheld terminals have their own GUI suitable for themselves, the handheld terminal cannot support all the markup language standards as can a desktop computer. Accordingly, the GUI characteristics of the markup language should be modified to be suitable for GUTI of the corresponding handheld terminal.

The syntax parser 320 of the present invention defines grammar structure as shown in FIG. 6 so as to parse various types of documents or a multi-document.

In FIG. 6, the document means a document supplied to the integral parser 214. Language A, language B and language C mean markup languages supporting HTML, WML, HDML, etc. In real grammar, the languages are elements representing a document that is a transmission unit.

Since the markup languages have different DTDs and partially include some functions of HTML, the elements whose types are the same in different DTDs are treated as the same element. FIG. 5 shows this fact abstractly.

In other words, as for the grammar structure of FIG. 6, a parser can parse a markup language supporting various standards. The parser parses all the DTDs to be supported and defines granmnar for each element.

Here, considering elements and attributes, most of the elements and the attributes can be used in various languages but some elements or attributes are limited to a specific language. Therefore, in the present invention, a system is designed to parse common factors of all the markups for presentation.

Table 2 represents the grammar structure of FIG. 6 in BUF format.

TABLE 2

| | |
|---|---|
| [1] | Document: = Language A\|Language B\|Language C |
| [2] | Language A: = [Element A′\|Element B′]*\|Language B\|Language |
| | C . . . |
| [3] | Element A′: = attributes contents |
| [4] | Attributes: = Attribute A″ Attribute B″ |
| [5] | Contents: = [Element B′\|Element C′]* . . . |
| [6] | Language B: = [Element A′\|Element D′]*\|Language A\|Language C |

The grammar of table 2 will be described. Line [1] means that a document to be parsed is composed of one of the languages supporting various standards. Line [2] means that each of the languages includes a contents model composed on the basis of its own DTD and also may include another language. Lines [3]-[5] means that each element can include an attribute and its own contents. Line [6] means that each of the languages may include a contents model composed on the basis of its own DTD and also may include another language as the line [2].

Described in added detail, the line [1] represents a root element in a document that is a transmission unit, for example, document:=html|hdml|wml. In general, a root element has the same character string as the name of the markup language. This determines the kind of the markup language.

The line [2] means that a root element includes several elements and embeds other markup languages. For example, html:=[head body]|hdml|wml.

The line [3] means that one element has attributes and contents. The line [4] represents the kind of the attributes, which the one element can have. For example, attributes:=name|title|align| . . . .

The line [5] represents that another element can come as contents of an element. For example, (body) contents:=p|br|hl| . . . .

The line [6] represents the element that the root element of one markup language can include, and means that the language A and the language C can be represented to embed a root element of another markup language. For example, wml:=card*|hdml|html| . . . .

Here, the grammar is only an embodiment. The body and the card are the element belonging to different markup languages. p and br are the elements commonly included.

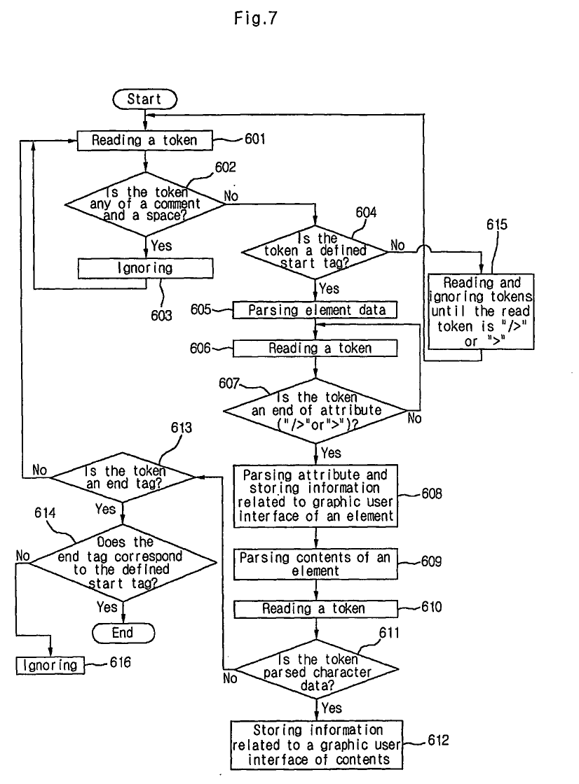

Referring to FIG. 7, a parsing procedure of web-document parsing system according to the present invention configured as described above, which parses various web-documents on the basis of element, will be described.

As shown in FIG. 7, the integral parser 214 of the present invention recognizes the beginning and the end of the parsing as the highest element. The integral parser 214 begins the parsing operation upon recognizing the start tag of the element and ends the parsing operation when recognizing the end tag of the element.

In the present invention, the word parser 310 parses the web-document responding to a request, reads a generated token, and determines whether the token is a comment or a space. If the read token is a comment or a space, the word parser 310 reads all the tokens but does not process the read tokens and reads a token to again recognize an element (step 601-603).

To the contrary, if the token read at the step 601 is not the comment or the space but the start tag of the element defined for an application program 212 (step 604), the attributes and contents of the element are all parsed (step 605) and the tags are read until the end of the attribute, that is, the end tag appears (steps 606-607). Finally information on GUI of an element and an attribute is stored (step 608).

The word parser 310 reads the remaining tokens after the syntax parser 320 parses the element contents (steps 609-610).

Then, at a step 611, it is determined whether the read tokens are parsed character data or not. If the read tokens are parsed character data, information related to GLTI of the contents is stored at a step 612. If the read tokens are not parsed character data, it is determined whether an end tag corresponding to the previously read tag informing a comment, a space, element or parsed character data such as a character string comes at a step 613.

If the token read at the step 613 does not come as the end tag, the steps are repeated from the step 601. If the end tag comes, it is determined whether the end tag is an end tag corresponding to the start tag defined at the step 614.

If the end tag defined by the token read at the step 614 does not come, it is ignored (step 616). If the end tag comes, it is terminated.

If it is parsed character data, that is, user data such as character string to be displayed on a screen appear at the step 611, related information is stored (step 612). If an end tag of a current element is read, the element parsing is terminated. If the start tag of an element defined at an application program 212 is read, it is regarded as element contents and the element is parsed.

Meanwhile, if the start tag of the element that was not defined at the application program is recognized at the step 604, tokens are read until a tag, an attribute and an end tag of an element appear. They are not processed but it returns to initial state (step 615).

As an example, it is assumed that the document provided to a parsing system is the following HDML document. It will be described that the HDML document is finally displayed by integral parsing of the present invention, by referring to FIGS. 2 to 7.

<!-- HDML example -->
<HDML>
<DISPLAY>
<ACTION TYPE = ACCEPT LEVEL = “Done”>
You just won the lottery!
</DISPLAY>
</HDML>

Methods for separating the element supported by a terminal 210 for the supplied document from the document can include a method of defining a token table on the basis of element supported by the terminal 210 and making the undefined token UNKNOWN token or ignoring the undefined token, and a method of defining all the tokens of the document and recognizing the tokens and making the application of the parser determine whether the tokens are used. Here, both of the methods need an element list supported by the terminal.

The operation of the parsing system according to the present invention will be described using the first method and the HDML example.

For this example, it is assumed that the terminal 210 can support hdml and display but cannot support action among the elements used in the HDML example.

In the token table 311 shown in FIG. 4, the supportable keywords are both defined. The token generator 312 shown FIG. 4 extracts a token from the document by using the token table 311 as follows.

In the initial state, the start of a comment is recognized from a token “<!--” and the token is read (601 of FIG. 7). The comment parser 410 reads all the contents in markup until the token “-->” appears, and then ignores the read contents (602 and 603 of FIG. 7).

Then, if an element defined after the token “<” is read, a markup start parser 420 reads the contents in markup until a token “>” or “/>” appears. The syntax parser 320 parses and stores the read contents (604-607 of FIG. 7).

When a space appears in an initial state, the space is ignored (602 and 603 of FIG. 7). Then, if an element not defined after a token “<” is read, a markup start parser 420 reads the contents in markup until a token “>” or “/>” appears and does not process the read contents. Then, the terminal returns to the initial state (step 615 of FIG. 7).

If the read token is parsed character data, the data parser 450 parses the contents of the data and stores GUI-relevant information on the contents (611 and 612 of FIG. 7).

The information transmitted from the word parser 310 to the syntax parser 320 in the procedure described above has the following form. An XML verifier 322 and a GUI-based object generator 323 of the syntax parser 320 parse the syntax through the contents model 321 on the basis of DTD of the document, forms a tree-based object on the basis of GUI of the terminal 210 and provides the tree-based object to a rendering editor.

<HDML>
<DISPLAY>
<ACTION TYPE = ACCEPT LEVEL = “Done”>
You just won the lottery!
</DISPLAY>
</HDML>

Here, attributes and a hierarchy structure between HDML and DISPLAY are defined in the document contents model 321. If the syntax of the information transmitted from the word parser 310 is parsed using the document contents model 321, it is found that the hierarchy structure is “HDML”→“DISPLAY”→“You just won the lottery!”

As a result, the parsing system 214 according to embodiments of the present invention described above, that is, the word parser 310 and the syntax parser 320 parse the document supplied to the terminal based 210 regardless of the kind of the document to browse the document for a user through an application program of the terminal 210.

The examples described above are only the embodiments of a system and a method for parsing an element-based web-document according to the present invention. While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

### INDUSTRIAL APPLICABILITY

As described above, in accordance with embodiments of the present invention, the conventional web site can be used when an integral parser is installed in the handheld terminal. Furthermore, only the information necessary for the application program of the terminal can be extracted.

Furthermore, according to the present invention, since Internet service provider does not have to construct a web site specialized for each terminal, time and cost can be saved.

1. A system for parsing a web-document based on elements, which is applied to an application of a handheld terminal and calls the web-document to provide it to the handheld terminal, comprising:
a word parser for separating a token on the basis of markup and non-markup by referring to a token table for all markup data necessary for kind of document to be supported; and
a syntax parser for parsing a contents model on the basis of document type definition (DTD) of each document, parsing each syntax on the basis of the result of parsing the contents model, and generating a tree-based object on the basis of graphic user interface (GUI) of the terminal.

2. The system of claim 1, wherein the word parser comprises:
a comment parser for processing a comment and a space;
a markup start parser for recognizing a markup start tag and generating a token;
an attribute parser for parsing an attribute and generating a token; and
a parsed character data analyzer for analyzing parsed character data and generating a token.

3. The system of claim 1, wherein the syntax parser comprises:
an XML verifier for verifying whether a corresponding document is composed suitable for each DTD on the basis of the token generated by the word parser; and
a terminal GUI-based object generator for matching the analyzed markup and a GUI of the terminal.

4. The system of claim 1, wherein the parsing system integrally parses a web-document composed on the basis of any one of SGML and XML related to HTML, XHTML, mHTML, cHTML, WML and HDML.

5. The system of claim 1, wherein the parsing system can be applied to any handheld terminal and select kind of an element to be parsed according to specification of each of the terminals.

6. A method for parsing a called web-document of a web-server, the method comprising the steps of:
(a) reading a token from the web-document and parsing the token;
(b) if the token is not a defined start tag or if the token is a comment or a space as result of the step (a), ignoring the token, and when the defined start tag is read, parsing an attribute of an element from the token;
(c) parsing the attribute of the element from the token, storing GUI-related information of the element, and parsing contents of the element;
(d) as the result of the step (c), if the contents of the element are parsed character data, storing GUI-related information of the contents, and if the contents of the element are not the parsed character data, reading data until an end tag appears; and
(e) in case the contents of the element are not the parsed character data, if the end tag corresponding to the start tag defined appears, terminating, and if the end tag does not appear, ignoring and returning.

7. The method of claim 6, wherein the step (c) comprises the steps of:
if the read token does not include a defined start tag, reading the data continuously until the end tag appears, thereby ignoring the token; and
reading a new token.

8. A recording medium for storing a program for parsing a called web-document of a web-server, the recording medium being read by a computer, the program comprising the functions of:
(a) reading a token from the web-document and parsing the token;
(b) if the token is not a defined start tag or if the token is a comment or a space as result of the function (a), ignoring the token, and when the defined start tag is read, parsing an attribute of an element from the token;
(c) parsing the attribute of the element from the token, storing GUI-related information of the element, and parsing contents of the element;
(d) if the contents of the element are parsed character data as result of the function (c), storing GUI-related information of the contents, and if the contents of the element are not the parsed character data, reading data until an end tag appears; and
(e) in case the contents of the element are not the parsed character data, if the end tag corresponding to the start tag defined appears, terminating, and if the end tag does not appear, ignoring and returning.

9. A system for parsing a web-document based on elements, which calls the web-document to provide it to a handheld terminal, comprising:
a word parser for extracting and separating all tokens of the web-document supplied regardless of kind of a markup language used to compose the web-document by referring to a token table; and
a syntax parser for parsing syntax for the tokens extracted and separated by the word parser on the basis of contents model, and generating an object on the basis of GUI of the terminal.

10. The system of claim 9, wherein the token table comprises:
tokens defined in an XML document;
keywords defined in DTD for all documents provided to the handheld terminal; and
a list of elements which can be supported by each terminal.

11. The system of claim 9, wherein the word parser comprises:
a comment parser for recognizing a comment or a space and generating a token;
a markup start parser for recognizing a markup start tag and generating a token;
an attribute parser for parsing an attribute and generating a token; and
a parsed character data analyzer for analyzing parsed character data and generating a token.

12. The system of claim 9, wherein the word parser comprises a token generator and an XML well-formedness verifier, receives the supplied document character by character, recognizes a token of the document on the basis of the token table, and extracts the token by using the token generator and the XML well-formedness verifier.

13. The system of claim 9, wherein the contents model means a hierarchy of elements and an attribute list, and is defined in DTD for all documents provided to the handheld terminal.

14. The system of claim 9, wherein the syntax parser comprises:
an XML verifier for verifying whether a web-document is composed suitable for each DTD supplied on the basis of the token extracted and separated by the word parser; and
a GUI-based object generator for matching the parsed syntax and a GUI of the terminal.

15. A system for parsing web-document based on elements, comprising:
a token table comprising tokens defined in an XML document, keywords defined in DTD for all documents provided to the handheld terminal, and a list of elements, which can be supported by each terminal;
a word parser for extracting and separating all tokens of the document supplied to the terminal regardless of kind of a markup language used to compose the web-document by referring to a token table;
a contents model defined in DTD for all documents provided to the terminal and meaning a hierarchy of elements and an attribute list; and
a syntax parser for parsing syntax for the tokens extracted and separated by the word parser on the basis of contents model, and generating an object on the basis of GUI of the terminal through the parsed syntax.

16. The system of claim 15, the word parser comprises:
a comment parser for recognizing a comment or a space and generating a token;
a markup start parser for recognizing a markup start tag and generating a token;
an attribute parser for parsing an attribute and generating a token; and
a parsed character data analyzer for analyzing parsed character data and generating a token.

17. The system of claim 15, wherein the word parser comprises a token generator and an XML well-formedness verifier, receives the supplied document character by character, recognizes a token of the document on the basis of the token table, and extracts the token by using the token generator and the XML well-formedness verifier.

18. The system of claim 15, wherein the syntax parser comprises:
an XML verifier for verifying whether a supplied web-document is composed suitable for each DTD supplied on the basis of the token extracted and separated by the word parser; and
a GUI-based object generator for matching the parsed syntax and a GUI of the terminal.

19. A handheld terminal comprising:
an integral parser for parsing a web-document composed of a predetermined markup language supplied from a web-server;
a memory for storing information parsed by the integral parser; and
an application program using information extracted from the integral parser.

20. A handheld terminal comprising an antenna, a CPU, a peripheral circuit, a vocoder, a memory and an audio codec, wherein the memory comprising:
an integral parser for calling a web-document supplied from a web-server regardless of a markup language used to compose the web-document and parsing the web-document on the basis of elements; and
an application program using information extracted from the integral parser.

21. The handheld terminal of claim 19 wherein the integral parser comprises:
a token table comprising tokens defined in an XML document, keywords defined in DTD for all documents provided to the handheld terminal, and a list of elements, which can be supported by each of the handheld terminals;
a word parser for extracting and separating all tokens of the document supplied to the terminal regardless of kind of a markup language used to compose the web-document by referring to a token table;
a contents model defined in DTD for all documents provided to the terminal and meaning a hierarchy of the elements and an attribute list; and
a syntax parser for parsing syntax for the tokens extracted and separated by the word parser on the basis of contents model, and generating an object on the basis of GUI of the terminal through the parsed syntax.

22. The system of claim 21, the word parser comprises:
a comment parser for recognizing a comment or a space and generating a token;
a markup start parser for recognizing a markup start tag and generating a token;
an attribute parser for parsing an attribute and generating a token; and
a parsed character data analyzer for analyzing parsed character data and generating a token.

23. The system of claim 21, wherein the word parser comprises a token generator and an XML well-formedness verifier, receives the supplied document character by character, recognizes a token of the document on the basis of the token table, and extracts the token by using the token generator and the XML well-formedness verifier.

24. The system of claim 21, wherein the syntax parser comprises:
an XML verifier for verifying whether a supplied web-document is composed suitable for each DTD supplied on the basis of the token extracted and separated by the word parser; and
a GUI-based object generator for matching the parsed syntax and a GUI of the terminal.

25. The handheld terminal of claim 19 wherein the application program comprises an object based on a GUI of the handheld terminal.

26. A method for parsing a web-document supplied from a web-server, the web-document being composed of a predetermined markup language, the method comprising the steps of:
(a) reading a token from the web-document by referring to a token table, extracting and separating the token;
(b) if the extracted and separated token is not a defined start tag or if the token is a comment or a space, ignoring the token;
(c) when the extracted and separated token is recognized as the defined start tag, parsing an attribute of an element from the token and storing GUI-related information of the element;
(d) parsing contents of the element after parsing the attribute of the element;
(e) as the result of the step (d), if the contents of the element are parsed character data, storing GUI-related information of the contents, and if the contents of the element are not the parsed character data, determining whether an end tag appears;
(f) as the result of the step (e), if the end tag does not appear, repeating from the step (a), and if the end tag appears, determining whether the end tag corresponds to the defined start tag; and
(h) as the result of the step (f), if the end tag corresponds to the defined start tag, terminating, and otherwise, ignoring and returning.

27. The method of claim 26, wherein the step (c) comprises the steps of:
if the extracted and separated token does not include a defined start tag, reading the data continuously until the end tag appears, thereby ignoring the token; and
reading a new token.
